(19) United States
(12) Patent Application Publication
(10) Pub. No.: US 2010/0128474 A1
(43) Pub. Date: May 27, 2010

(54) LED LAMP

(75) Inventors: CHIN-CHUNG CHEN, Tu-Cheng (TW); JIA-CHUAN LV, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/393,042

(22) Filed: Feb. 26, 2009

(30) Foreign Application Priority Data
Nov. 25, 2008 (CN) 200810305731.1

(51) Int. Cl. F21S 4/00; F21V 1/00; G02B 7/02

(52) U.S. Cl. 362/235; 362/249.02; 359/808

(57) ABSTRACT

An LED lamp includes a printed circuit board, a plurality of LED modules mounted on the printed circuit board, and a lens mounted on the printed circuit board and covering the LED modules. The lens includes a bottom surface enclosing the LED modules therein and a top surface located above the bottom surface. Light emitted from the LED modules travels through the bottom surface and the top surface of the lens to illuminate the environment. The bottom surface of the lens is concave and the top surface of the lens is bulgy. Curvatures of constituting portions of the bottom surface are larger than those of corresponding portions constituting the top surface.

### BACKGROUND OF THE INVENTION

1. Field of the Invention

The invention relates to LED (light emitting diode) lamps, and, more particularly, to an LED lamp having an improved lens, whereby light generated by the LED lamp can have a better pattern of distribution.

2. Description of Related Art

The technology of LEDs has rapidly developed in recent years from indicators to illumination applications. With the features of long-term reliability, environment friendliness and low power consumption, the LED is viewed as a promising alternative for future lighting products.

A conventional LED lamp comprises a heat sink, a plurality of LED modules having LEDs attached to an outer surface of the heat sink to dissipate heat generated by the LEDs and a transparent envelope mounted on the heat sink and covering the LED modules therein. The outer surface of the heat sink generally is planar and the LEDs are arranged close to each other. The envelope is used to protect the LEDs from damage. The LED lamp further has a lens for directing light generated by the LEDs to have a desired pattern of distribution, thereby meeting a set lightening requirement. However, the conventional lens cannot enable the light generated by the LEDs to have an optimal pattern of distribution.

What is needed, therefore, is an LED lamp which can overcome the disadvantages of the prior art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled view of an LED lamp in accordance with an embodiment of the present disclosure.

FIG. 2 is an exploded view of FIG. 1.

FIG. 3 is a side view of the LED lamp of FIG. 2.

FIG. 4 is a luminous intensity curve graph of the LED lamp of FIG. 1 of the present disclosure.

### DETAILED DESCRIPTION OF THE INVENTION

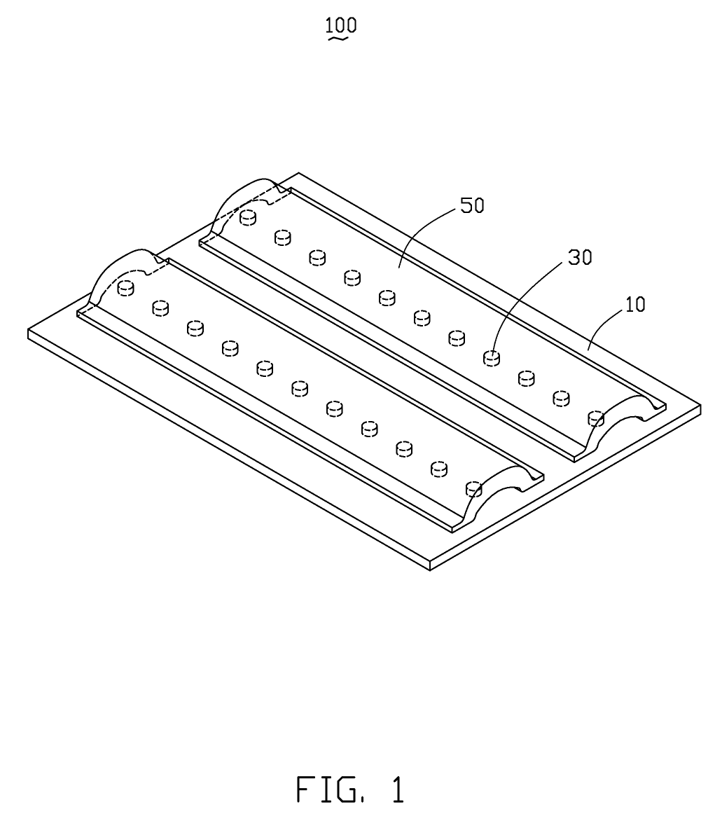

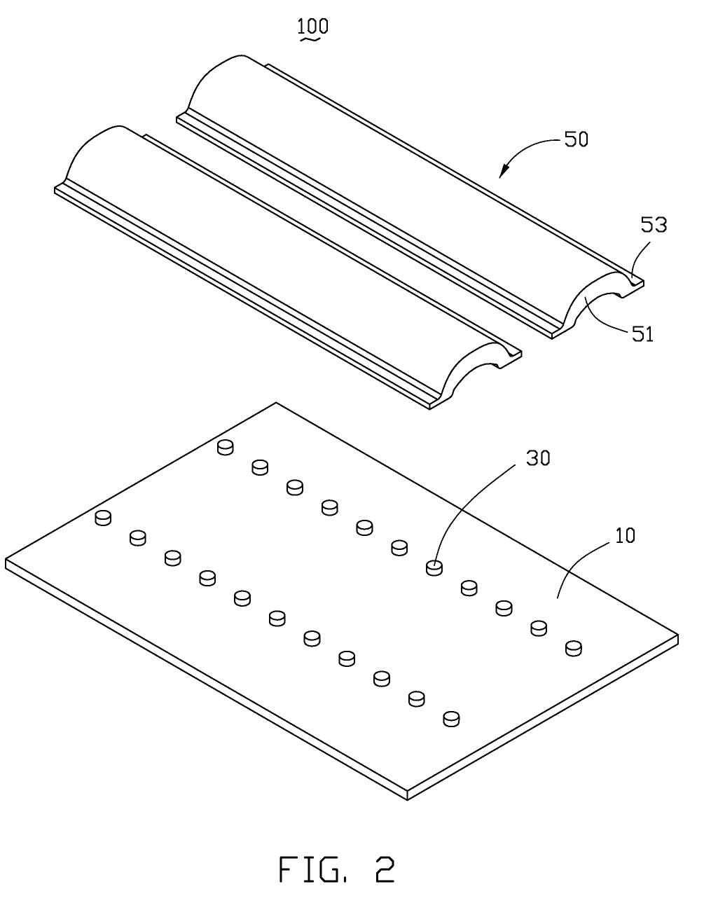

Referring to FIGS. 1-2, an LED lamp 100 comprises an elongated printed circuit board 10, a plurality of LED modules 30 mounted on the printed circuit board 10, and two lenses 50 mounted on the printed circuit board 10 and covering the LED modules 30.

The LED modules 30 are divided into two spaced, parallel rows along a direction from a front end to a rear end of the printed circuit board 10. Two adjacent LED modules 30 of each of the rows are spaced from each other. The two lenses 50 cover the two rows of the LED modules 30, respectively.

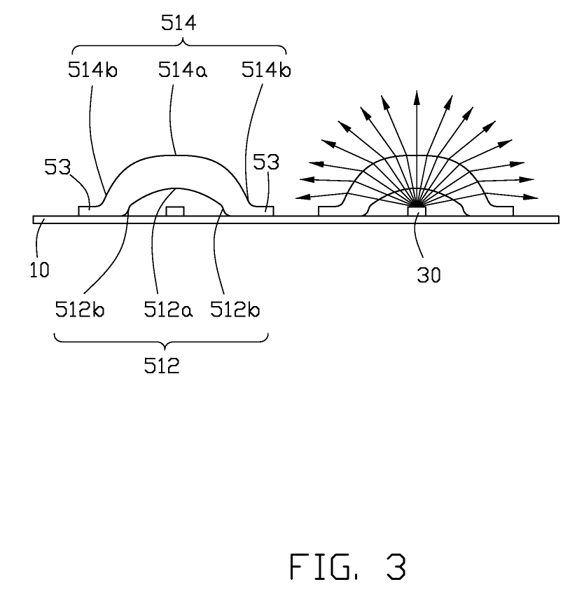

Referring to FIG. 3 also, each of the lenses 50 is made of a transparent material such as Polymethyl methacrylate (PMMA) or Polycarbonate (PC). Each of the lenses 50 comprises an arc-shaped body 51 and two elongated mounting portions 53 extending outwardly from lateral ends of the body 51. Bottom surfaces of the two mounting portions 53 are coplanar and mounted on the printed circuit board 10. The lens 50 extends over the corresponding row of the LED modules 30 to cover the LED modules 30 therebelow. The body 51 comprises a concave bottom surface 512 and a bulgy top surface 514 located above the bottom surface 512. The bottom surface 512 and the top surface 514 are respectively constituted by arc-shaped surfaces with different curvatures. The LED modules 30 are covered by and spaced from the bottom surface 512. Light emitted from the LED modules 30 travels through the bottom surface 512 of the lens 50 into the body 51 and then travels through the top surface 514 into the ambient air.

The bottom surface 512 includes a first central surface 512a directly over the LED modules 30 and two first lateral surfaces 512b respectively adjoining two ends of the first central surface 512a. The top surface 514 includes a second central surface 514a corresponding to the first central surface 512a of the bottom surface 512 and two second lateral surfaces 514b respectively adjoining two ends of the second central surface 514a. Each of the first central surface 512a and the second central surface 514a is an arc-shaped surface. The first central surface 512a and the second central surface 514a have different curvatures. The curvature of the first central surface 512a is larger than that of the second central surface 514a. The curvature of the second central surface 514a is smaller than that of each of the second lateral surfaces 514b. The curvature of the first central surface 512a is smaller than that of each of the first lateral surfaces 512b.

The two first lateral surfaces 512b are corresponding to the two second lateral surfaces 514b, respectively. The curvature of each of the two first lateral surfaces 512b is larger than that of each of the two second lateral surfaces 514b. The two first lateral surfaces 512b can have a same curvature or different curvatures. Similarly, the two second lateral surfaces 514b can have a same curvature or different curvatures. In the present embodiment, the two first lateral surfaces 512b have a same curvature, and the two second lateral surfaces 514b have a same curvature.

Regarding the light emitted from the LED modules 30, one portion of the light moves upwardly to enter the body 51 of the lens 50 via the first central surface 512a, and spreads outside of the body 51 of the lens 50 from the second central surface 514a. That is, on the second central surface 514a of the body 51, a part of the light which corresponds to a central portion of the second central surface 514 is not refracted and directly spreads outside of the body 51; another part of the light which corresponds to opposite portions of the second central surface 514 is refracted by the second central surface 514 before it enters the ambient air. The another part of the upwardly moved light is first refracted by opposite portions of the first central surface 514 before it enters the body 51 of the lens 50. Another portion of the light emitted from the LED modules 30 enters the body 51 from the two first lateral surfaces 512b of the bottom surface 512. Due to the curvatures of the two first lateral surfaces 512b being larger than those of the two second lateral surfaces 514b, the another portion of the light emitted from the LED modules 30 is refracted twice with different degrees (first by the two first lateral surfaces 512b of the bottom surface 512 of the lens 50 and then by the two second lateral surfaces 514b of the top surface 514 of the lens 50) to radiate from the lens 50. Thus, a total internal reflection phenomenon occurring at the top surfaces 514 of the lenses 50 can be greatly avoided. The light emitted from the LED modules 30 is oriented toward a plurality of different directions, whereby the LED lamp 100 in accordance with the present disclosure can have a large illumination angle.

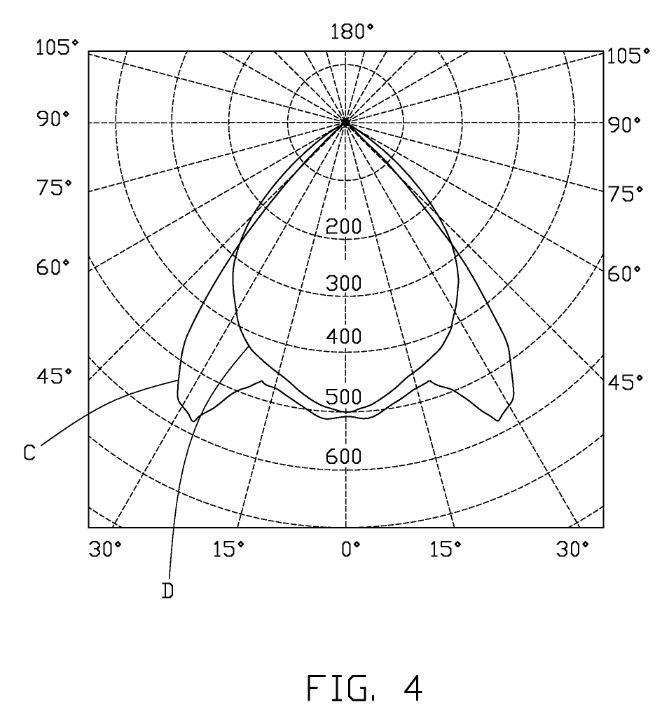

FIG. 4 shows a luminous intensity curve graph of the LED lamp 100 of the present disclosure. Referring to FIG. 4, a curve C shows a luminous intensity curve of the LED lamp 100 along a first direction (i.e. a transverse direction of the LED lamp 100), and a curve D shows a luminous intensity curve of the LED lamp 100 along a second direction perpendicular to the first direction. The LED lamp 100 in accordance with the present disclosure can have a light output efficiency of more than 85%, which is larger than that of the conventional lamp. Therefore, the LED lamp 100 meets the luminous intensity requirement and saves energy at the same time.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments of the disclosure.

What is claimed is:

1. An LED (light emitting diode) lamp comprising:
a printed circuit board;
a plurality of LED modules mounted on the printed circuit board; and
a lens mounted on the printed circuit board and covering the LED modules, the lens comprising a bottom surface covering the LED modules therein and a top surface located above the bottom surface and remote from the LED modules, light emitted from the LED modules traveling through the bottom surface and the top surface of the lens to illuminate an environment;
wherein the top and bottom surfaces are arc-shaped with different curvatures, the bottom surface having a first central portion and two first lateral portions and the top surface having a second central portion and two second lateral portions, a curvature of each of the first lateral portions being larger than that of each of the second lateral portions.

2. The LED lamp as claimed in claim 1, wherein the bottom surface of the lens is a concave surface and located over the LED modules.

3. The LED lamp as claimed in claim 1, wherein a curvature of the first central portion of the bottom surface is larger than that of the second central portion of the top surface.

4. The LED lamp as claimed in claim 1, wherein two mounting portions extend outwardly from lateral ends of the lens and are mounted on the printed circuit board.

5. The LED lamp as claimed in claim 4, wherein each of the mounting portions is elongated and bottom surfaces of the mounting portions are coplanar.

6. The LED lamp as claimed in claim 1, wherein the lens is made of Polymethyl methacrylate (PMMA) or Polycarbonate (PC).

7. A lens adapted for directing light emitted from an LED light source, comprising:
a bottom surface adapted for enclosing the LED light source therein and a top surface located above the bottom surface, light emitted from the LED light source traveling through the bottom surface and the top surface of the lens to illuminate an environment;
wherein the top and bottom surfaces are arc-shaped, each consisting of a plurality of portions having different curvatures and connecting together, and curvatures of the portions of the top surface are less than those of corresponding portions of the bottom surface.

8. The lens as claimed in claim 7, wherein the top surface is bulgy.

9. The lens as claimed in claim 7, wherein the bottom surface of the lens is a concave surface.

10. The lens as claimed in claim 7, wherein the portions of the bottom surface comprises a first central portion and two first lateral portions respectively adjoining two ends of the first central portion, and the portions of the top surface comprises a second central portion corresponding to the first central portion of the bottom surface and two second lateral portions respectively adjoining two ends of the second central portion and corresponding to the first lateral portions of the bottom surface.

11. The lens as claimed in claim 10, wherein the first lateral portions of the bottom surface and the second lateral portions of the top surface are arc-shaped and curvatures of the two first lateral portions are larger than those of the two second lateral portions.

12. The lens as claimed in claim 11, wherein a curvature of the first central portion of the bottom surface is larger than that of the second central portion of the top surface.

13. The lens as claimed in claim 7, wherein two mounting portions extend outwardly from lateral ends of the lens adapted for mounting the lens on a determined portion.

14. The lens as claimed in claim 7, wherein each of the mounting portions is elongated and bottom surfaces of the mounting portions are coplanar.

15. The lens as claimed in claim 7, wherein the lens is made of Polymethyl methacrylate (PMMA) or Polycarbonate (PC).

16. The lens as claimed in claim 10, wherein the second central portion has a curvature smaller than that of each of the second lateral portions.

17. The lens as claimed in claim 10, wherein the first central portion has a curvature smaller that of each of the first lateral portions.
